(19) United States
(12) Patent Application Publication
(10) Pub. No.: US 2018/0139790 A1
(43) Pub. Date: May 17, 2018

(54) METHODS, APPARATUSES AND STORAGE MEDIUM FOR CONTROLLING A WIRELESS CONNECTION

(71) Applicant: Beijing Xiaomi Mobile Software Co., Ltd., Beijing (CN)

(72) Inventor: Enxing HOU, Beijing (CN)

(73) Assignee: Beijing Xiaomi Mobile Software Co., Ltd., Beijing (CN)

(21) Appl. No.: 15/812,218

(22) Filed: Nov. 14, 2017

(30) Foreign Application Priority Data
Nov. 14, 2016 (CN) 201611000825.9

(51) Int. Cl. H04W 76/02; H04W 8/00

(52) U.S. Cl. CPC H04W 76/025; H04W 84/12; H04W 8/005

(57) ABSTRACT

The present disclosure relates to methods, apparatuses and a non-transitory computer-readable storage medium for controlling a wireless connection. The method includes detecting that a mobile terminal is entering a range of a first network using a first connection protocol when an electronic device is connected to a server via a wireless local area network provided by a router, establishing a first connection between the mobile terminal and the electronic device using the first connection protocol where the first connection protocol causes the electronic device to have a power consumption that is lower than that required to communicate using the wireless local area network, and disabling the wireless local area network for the electronic device, and performing communication between the electronic device and the server through the first connection and a second connection, wherein the second connection is used to connect the mobile terminal and the server.

### CROSS-REFERENCE TO RELATED APPLICATIONS

This application is based upon and claims the priority of the Chinese patent application No. 201611000825.9, filed on Nov. 14, 2016, the content of which is incorporated herein by reference in its entirety.

### TECHNICAL FIELD

The present disclosure generally relates to the technical field of the terminal device, and more particularly, to a method, an apparatus and a storage medium for controlling a wireless connection.

### BACKGROUND

“Smart homes” refer to homes including devices that are programmable and/or have internet access and/or are otherwise adapted to communicate with users or other devices. The number of smart homes have been increasing steadily. Within the smart home, a user may control electronic devices at home to perform various operations as desired. The implementation of the versatile functions of the smart home requires the connection between the electronic devices and a server for the data communication. When an electronic device is connected to a server by accessing a wireless local area network provided by a router, a considerable amount of power may be consumed.

### SUMMARY

The present disclosure provides a method, an apparatus and a non-transitory computer-readable storage medium for controlling a wireless connection.

According to a first aspect of the present disclosure, a method for controlling a wireless connection is provided. The method may include: detecting that a mobile terminal is entering a range of a first network using a first connection protocol when an electronic device is connected to a server via a wireless local area network provided by a router, establishing a first connection between the mobile terminal and the electronic device using the first connection protocol when the mobile terminal is detected to be within the range of the first network, where the first connection protocol causes the electronic device to have a power consumption that is lower than that required to communicate using the wireless local area network, and disabling the wireless local area network for the electronic device, and performing communication between the electronic device and the server through the first connection and a second connection, wherein the second connection is used to connect the mobile terminal and the server.

According to a second aspect of the present disclosure, an apparatus for controlling a wireless connection is provided. The apparatus may include: a processor; and a memory for storing instructions executable by the processor; where the processor may be configured to cause the apparatus to: detect that a mobile terminal is entering a range of a first network using a first connection protocol when an electronic device is connected to a server via a wireless local area network provided by a router, establish a first connection between the mobile terminal and the electronic device using the first connection protocol when the mobile terminal is detected to be within the range of the first network where the first connection protocol causes the electronic device to have a power consumption that is lower than that required to communicate using the wireless local area network, and disable the wireless local area network for the electronic device, and perform communication between the electronic device and the server through the first connection and a second connection where the second connection is used to connect the mobile terminal and the server.

According to a third aspect of the embodiments of the present disclosure, a non-transitory computer-readable storage medium is provided to have stored instructions therein. When the instructions are executed by a processor of an electronic device, the instructions may cause the electronic device to: detect that a mobile terminal is entering a range of a first network using a first connection protocol when an electronic device is connected to a server via a wireless local area network provided by a router, establish a first connection between the mobile terminal and the electronic device using the first connection protocol when the mobile terminal is detected to be within the range of the first network where the first connection protocol causes the electronic device to have a power consumption that is lower than that required to communicate using the wireless local area network, and disable the wireless local area network for the electronic device, and perform communication between the electronic device and the server through the first connection and a second connection where the second connection is used to connect the mobile terminal and the server.

It is to be understood that both the foregoing general description and the following detailed description are exemplary only and are not restrictive of the present disclosure.

### BRIEF DESCRIPTION OF THE DRAWINGS

The accompanying drawings herein, which are incorporated in and constitute a part of this specification, illustrate embodiments consistent with the present disclosure and, together with the description, serve to explain the principles of the present disclosure.

FIG. 1 is a flowchart illustrating a method for controlling a wireless connection according to an aspect of the present disclosure;

FIG. 2 is a flowchart illustrating another method for controlling a wireless connection according to another aspect of the present disclosure;

FIG. 3 is a flowchart illustrating a method for controlling a wireless connection according to a further aspect of the present disclosure;

FIG. 4 shows a block diagram illustrating an apparatus for controlling a wireless connection according to an aspect of the present disclosure;

FIG. 5 shows a block diagram illustrating another apparatus for controlling a wireless connection according to another aspect of the present disclosure;

FIG. 6 shows a block diagram illustrating an apparatus for controlling a wireless connection according to a further aspect of the present disclosure;

FIG. 7 is shows block diagram illustrating an apparatus configured to control a wireless connection according to an example of the present disclosure; and

FIG. 8 shows a block diagram illustrating another apparatus configured to control a wireless connection according to another example of the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

Reference will now be made in detail to examples of the present disclosure, the examples of which are illustrated in the accompanying drawings. The following description refers to the accompanying drawings in which the same numbers in different drawings represent the same or similar elements unless otherwise represented. The implementations set forth in the following description of examples do not represent all implementations consistent with the present disclosure. Instead, they are merely examples of devices and methods consistent with aspects related to the present disclosure as recited in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an example is included in at least one embodiment of the present disclosure. Thus, the appearances of the phrases “in one embodiment,” “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

The systems and methods of the present disclosure will be described with respect to any of a variety of operational scenarios that may include an electronic device, which may be a home appliance, a smart wearable device, a medical device or the like in a smart home system. The operational scenarios may also include a mobile terminal, which may be, for example, a mobile terminal such as a smart phone, a tablet PC, a smart TV, a smart watch, a PDA (Personal Digital Assistant), a portable computer or the like. Both of the electronic device and the mobile terminal may support for multiple networking or communications protocols Wireless Local Area Network (WLAN) protocols and Bluetooth protocols.

In the present disclosure, Bluetooth may support Bluetooth Low Energy (BLE) technology. WLAN may be Wi-Fi, and the WLAN function of the electronic device and the mobile terminal may refer to Wi-Fi function. The examples will be described when both of the electronic device and the mobile terminal may support a first connection protocol of BLE.

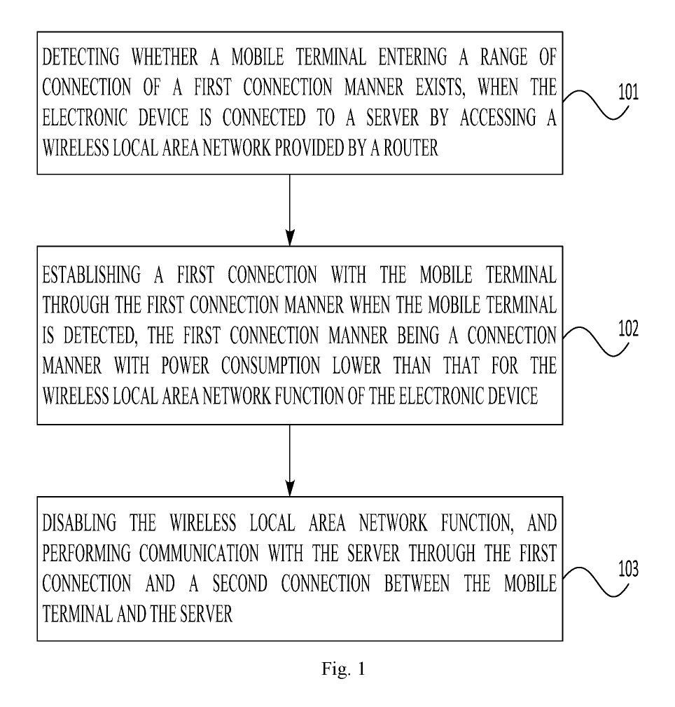

FIG. 1 is a flowchart illustrating a method for controlling a wireless connection according to an aspect of the present disclosure. As shown in FIG. 1, the method may be implemented in an electronic device. The method may include the following steps.

At step 101, when the electronic device is connected to a server by accessing a WLAN provided by a router, it is detected whether a mobile terminal entering a range of connection of a first connection protocol exists.

For example, the electronic device generally accesses the Wi-Fi network provided by the router through a Wi-Fi connection protocol. As such, the data communication with the server may be using this Wi-Fi network. In case where the first connection protocol is BLE, when the electronic device performs data communication with the server by connecting to the router through the Wi-Fi connection, it may be detected in real time whether a mobile terminal exists within the range of the BLE connection. The range of the BLE connection may also be referred as the range of a first network.

For example, both of the electronic device and the mobile terminal may emit BLE signals at a preset cycle. Thus, other devices supporting BLE function may find the electronic device or the mobile terminal. Therefore, the electronic device may search for BLE signals of other devices at a fixed time interval. Generally, a mobile terminal, when its BLE function is enabled, may also search for BLE signals of other devices at a fixed time interval. When a mobile terminal moves into a range of BLE connection of the electronic device, the electronic device may capture the BLE signal of the mobile terminal. At this time, the mobile terminal generally may also find the electronic device. Then, both of them may establish connection using BLE.

At step 102, when a mobile terminal is detected, a first connection may be established with the mobile terminal using the first connection protocol. The first connection protocol may be a connection protocol with the power consumption that is lower than that required for the WLAN function of the electronic device.

For example, in case where the first connection protocol is BLE, when the electronic device detects a mobile terminal that is in the range of the BLE connection, it may be firstly determined whether the mobile terminal has previously established a bundling relationship with the electronic device. For example, the electronic device may store a terminal list for recording connectable mobile terminals. The list may record one or more mobile terminals which have previously established bundling relationship with the electronic device.

When the electronic device detects a mobile terminal, the electronic device may determine the identity of the mobile terminal within the list. If the identification such as a device number, a device name or a network identification of the mobile terminal is in the terminal list, it may be determined that the mobile terminal has been bundled with the electronic device. In this case, the electronic device may establish the first connection with the mobile terminal using BLE.

In addition, if the identification of the mobile terminal is not in the terminal list, the electronic device may not perform any activities. Alternative, the electronic device may first establish a bundling relationship with the mobile terminal and then establish a first connection with the mobile terminal through BLE.

In this example, the bundling relationship between the electronic device and the mobile terminal may be performed by a smart home application (APP) that is installed on the mobile terminal. Each mobile terminal may be bundled with one or more electronic devices by the APP.

At step 103, the WLAN function is disabled, and the communication is performed with the server through the first connection and a second connection between the mobile terminal and the server.

In this example, the WLAN function may be disabled for the electronic device, and the second connection may be used to connect the mobile terminal and the server and may be a connection established by the mobile terminal with the server through the above mentioned WLAN, such as Wi-Fi, or a data network, such as 3G, 4G. The mobile terminal may establish a connection with the server using any one of the above mentioned protocols, which may be selected by the mobile terminal.

It may not be necessary for the electronic device to know about the connection protocol between the mobile terminal and the server. Since the BLE connection protocol may have the power consumption that is lower than that of Wi-Fi in a standby mode, for data transmission and in other aspects, after the electronic device establishes a connection with the mobile terminal through the BLE connection protocol, the Wi-Fi function of the electronic device may be disabled. The electronic device may communicate with the server through the BLE connection with the mobile terminal, the first connection established through BLE and the second connection between the mobile terminal and the server. Thus, it is possible to reduce the power consumption for communication between the electronic device and the server.

As an example, after the electronic device establishes the first connection with the mobile terminal detected at step 101 through the BLE connection protocol, the electronic device may send data to the mobile terminal using the first connection, and the mobile terminal may forward the data which is sent from the electronic data to the server through the second connection.

When the server is about to send data to the electronic device, the server may firstly send the data to the mobile terminal through the second connection and then the mobile terminal may forward the data which is sent from the server to the electronic device through the first connection. Accordingly, the mobile terminal serves as a relay for communication between the electronic device and the server. Since the first connection is a connection with the mobile terminal in the BLE connection protocol which has the power consumption that is lower than that of Wi-Fi, it is possible to reduce the power consumption for communication between the electronic device and the server.

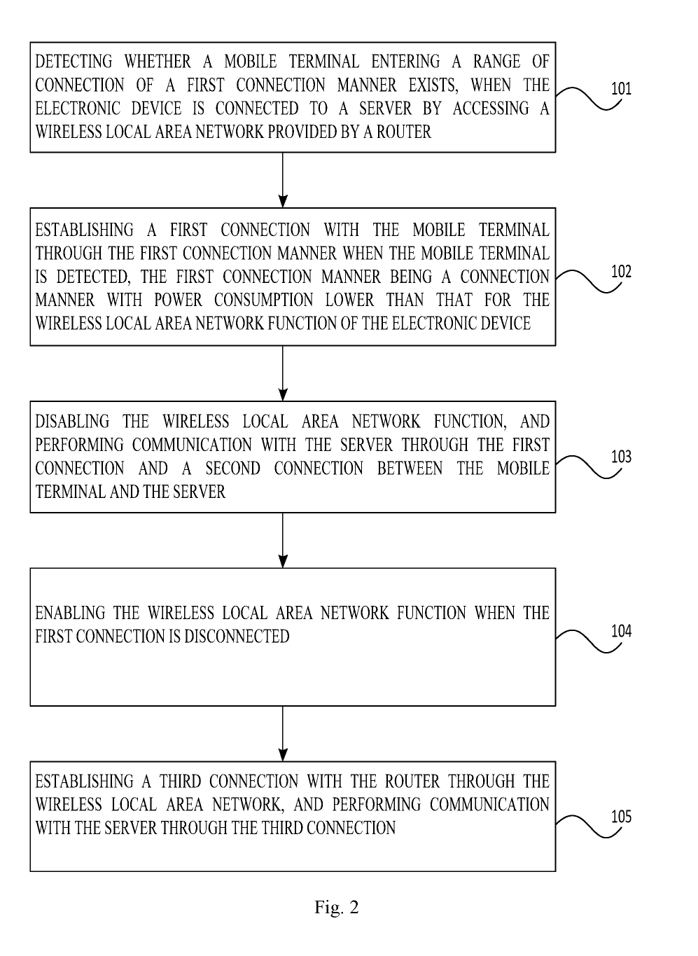

FIG. 2 is a flowchart illustrating another method for controlling a wireless connection according to another aspect of the present disclosure. As shown in FIG. 2, based on the method for controlling the wireless connection as shown in FIG. 1, the method may also include the following steps.

At step 104, when the first connection is disconnected, the WLAN function of the electronic device is enabled.

Also in the example when the WLAN is a Wi-Fi network and the first connection protocol is BLE, when the mobile terminal connected to the electronic device at step 102 moves out of the connection range of the BLE connection protocol, the first connection between the electronic device and the mobile terminal may be disconnected, and then, the Wi-Fi function of the electronic device needs to be enabled.

At step 105, a third connection is established with the router through the WLAN, and the communication is performed with the server through the third connection.

For example, after the electronic device enables the Wi-Fi function, the electronic device may access the Wi-Fi network provided by the router, and a third connection is thus established. Then, the electronic device may perform data communication with the server through the Wi-Fi network.

Accordingly, in the method for controlling the wireless connection provided by this example, when the electronic device is connected to the server by accessing a WLAN provided by a router, once it is detected that a mobile terminal has entered a range of connection of a first connection protocol, the electronic device establishes a connection with the mobile terminal through the first connection protocol, and disable the WLAN function. The electronic device thus can perform the communication with the server via the mobile terminal through the first connection protocol which has a power consumption that is lower than that for the WLAN function.

As such, this method may reduce the power consumption for the connection between the electronic device and the server, particularly may reduce the power consumption for wireless communication between the electronic device and the server.

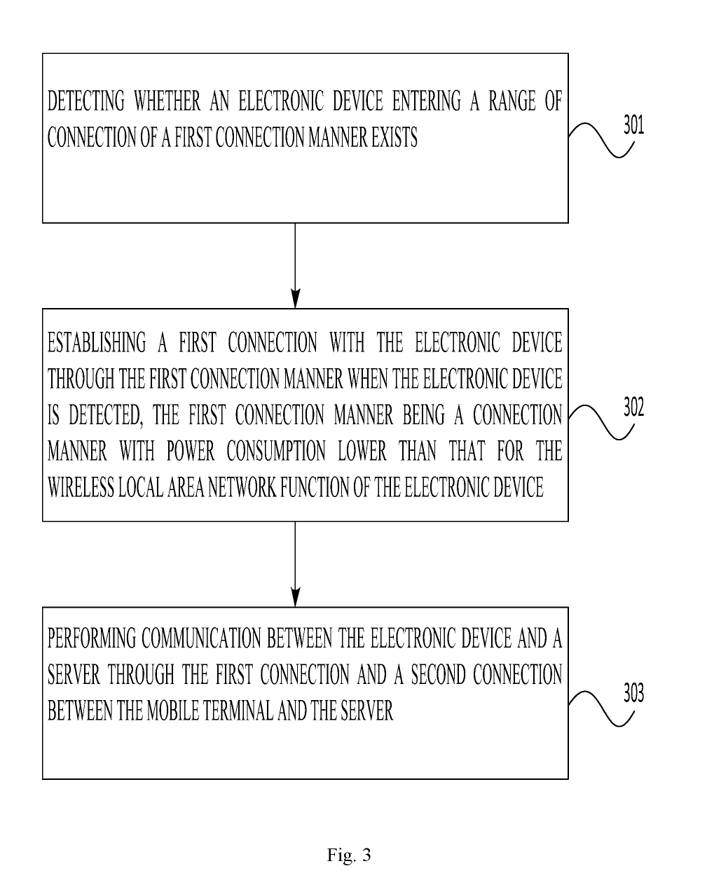

FIG. 3 is a flowchart illustrating a method for controlling a wireless connection according to a further aspect of the present disclosure. As shown in FIG. 3, the method may be implemented in a mobile terminal. The method may include the following steps.

At step 301, it is detected whether an electronic device that enters a range of connection of a first connection protocol exists.

For example, in case where the first connection protocol is BLE, the mobile terminal may search for a connectable BLE signal at a fixed time interval, or search for a connectable BLE signal within a preset time period. Alternatively, the mobile terminal may search for an electronic device within a corresponding preset time period according to a list of connectable BLE signals preset in the mobile terminal. For example, both of the electronic device and the mobile terminal may emit BLE signals at a preset cycle. Other devices supporting BLE function may find the electronic device or the mobile terminal according to the BLE signals. Therefore, the electronic device may search for BLE signals of other devices at a fixed time interval.

Generally, for a mobile terminal, when its BLE function is enabled, the mobile terminal may also search for BLE signals of other devices at a fixed time interval. When a mobile terminal moves into a range of BLE connection of the electronic device, the mobile terminal may capture the BLE signal of the electronic device. At this time, the electronic device generally may also find the mobile terminal. Then, both of them may establish connection through BLE.

At step 302, when an electronic device is detected, a first connection is established with the electronic device through the first connection protocol, and the first connection protocol may be a connection protocol with the power consumption that is lower than that for the WLAN function of the electronic device.

In this example, the process of the mobile terminal establishing the first connection with the electronic device detected at step 301 through the BLE connection protocol is similar to the process of establishing connection at step 102, which is not repeated herein.

At step 303, the communication between the electronic device and a server is performed through the first connection and a second connection may exist between the mobile terminal and the server.

After the mobile terminal establishes the first connection with the electronic device, the electronic device may send data to the mobile terminal through the first connection, and the mobile terminal may forward the data which is sent from the electronic data to the server through the second connection.

When the server is about to send data to the electronic device, the server may firstly sent the data to the mobile terminal through the second connection and then the mobile terminal may forward the data which is sent from the server to the electronic device through the first connection.

Accordingly, the mobile terminal may serve as a relay for communication between the electronic device and the server. Since the connection with the mobile terminal is in the BLE connection protocol which has that power consumption that is lower than that of Wi-Fi, it is possible to reduce the power consumption for the communication of the electronic device.

In this example, the second connection between the mobile terminal and the server may be a connection established by the mobile terminal with the server through the above mentioned WLAN, such as Wi-Fi, or a data network, such as 3G, 4G. The mobile terminal may establish a connection with the server through any one of the above mentioned protocols, which may be selected by the mobile terminal. It is not necessary for the electronic device to know about the connection protocol between the mobile terminal and the server.

Sometimes, the mobile terminal may keep track of the power consumption. For example, the mobile terminal may display the power consumption of the first connection and second connection via a user interface.

Sometimes, the mobile terminal may provide comparisons of power consumption for different communication methods. For example, the power consumption for Wi-Fi and BLE for a period of time may be obtained and may be displayed in the user interface.

Sometimes, along with the comparisons, the mobile terminal may provide a selection option via the user interface to allow the user to select the communication method between the mobile terminal and electric device and/or between the mobile terminal and server. Such selection option may provide the option for the user to select a suitable communication method even though it may consume more power. For example, when Wi-Fi may consume less power than 4G for a mobile terminal to connect the server. However, because the user may have already purchased a big amount of 4G data plan while may need to pay extra for using the Wi-Fi on the spot, the user may choose to use the 4G over Wi-Fi for a particular communication period even though Wi-Fi may consume less power.

Accordingly, in the method for controlling the wireless connection provided by the example, when the electronic device is connected to the server by accessing a WLAN provided by a router, once it is detected that a mobile terminal has entered a range of connection of a first connection protocol, the electronic device may establish a connection with the mobile terminal through the first connection protocol, and disable the WLAN function. The electronic device may perform the communication with the server via the mobile terminal through the first connection protocol which has a power consumption that is lower than that for the WLAN function. Thus, this method may solve the problem that the power consumption is big for the connection between the electronic device and the server by reducing the power consumption for wireless communication between the electronic device and the server.

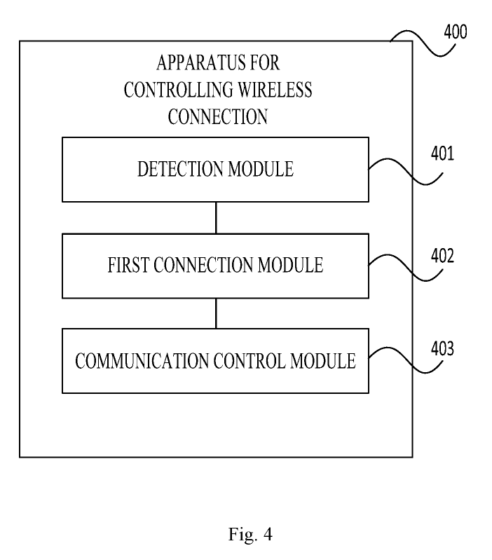

FIG. 4 shows a block diagram illustrating an apparatus for controlling a wireless connection according to an aspect of the present disclosure. As shown in FIG. 4, the apparatus may be implemented in an electronic device. The apparatus may include a detection module 401, a first connection module 402 and a communication control module 403.

The detection module 401 may be configured to detect whether a mobile terminal entering a range of connection of a first connection protocol exists when the electronic device is connected to a server by accessing a wireless local area network provided by a router.

The first connection module 402 may be configured to establish a first connection with the mobile terminal through the first connection protocol when the mobile terminal is detected, the first connection protocol may be a connection protocol with that power consumption that is lower than that for the wireless local area network function of the electronic device.

The communication control module 403 may be configured to disable the wireless local area network function, and perform the communication with the server through the first connection and a second connection between the mobile terminal and the server.

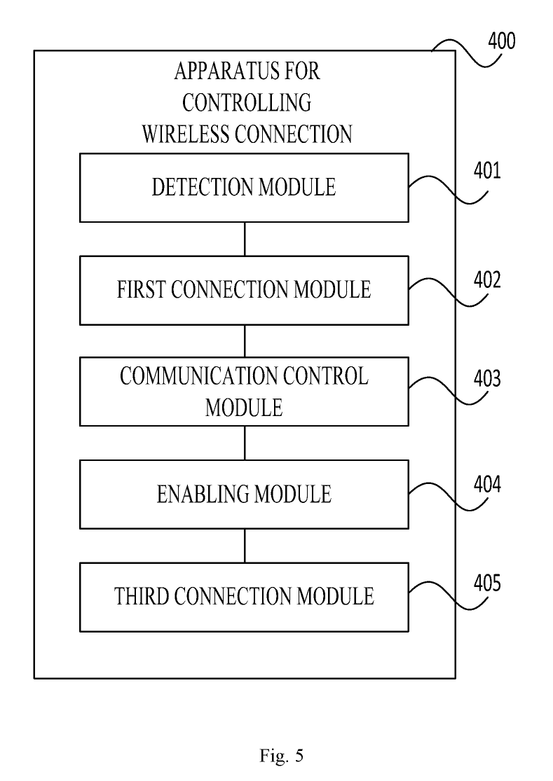

FIG. 5 is a block diagram illustrating another apparatus for controlling a wireless connection according to another aspect of the present disclosure. As shown in FIG. 5, based on the apparatus for controlling the wireless connection as shown in FIG. 4, the apparatus may also include an enabling module 404 and a third connection module 405.

The enabling module 404 may be configured to enable the wireless local area network function of the electronic device when the first connection is disconnected.

The third connection module 405 may be configured to establish a third connection between the wireless local area network and the router, and perform the communication with the server through this third connection.

Optionally, the second connection is a connection established by the mobile terminal with the server through the wireless local area network or a data network.

Optionally, the wireless local area network may include Wi-Fi based network, and the first connection protocol may include Bluetooth Low Energy BLE.

With respect to the apparatus in the above examples, the specific protocols for performing operations for individual modules therein have been described in detail in the examples regarding the relevant methods, which is not elaborated herein.

Accordingly, in the apparatus for controlling the wireless connection provided by the present example, when the electronic device is connected to the server by accessing a WLAN provided by a router, once it is detected that a mobile terminal has entered a range of connection of a first connection protocol, the electronic device may establish a connection with the mobile terminal through the first connection protocol. The electronic device may also disable the WLAN function. The electronic device may perform the communication with the server via the mobile terminal through the first connection protocol which has a power consumption that is lower than that for the WLAN function. Thus, it may solve the problem that the power consumption is large for the connection between the electronic device and the server by reducing the power consumption for wireless communication between the electronic device and the server.

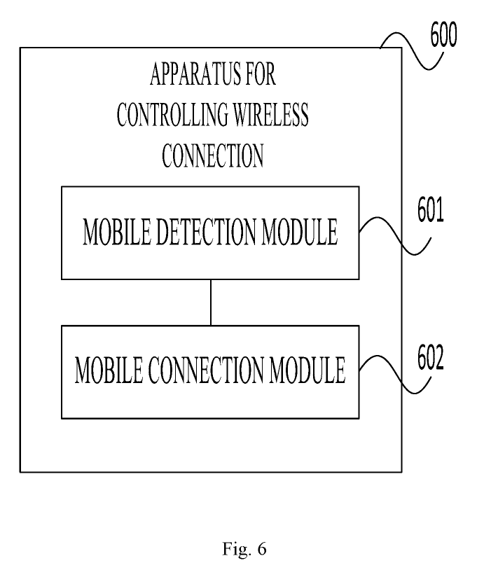

FIG. 6 is a block diagram illustrating an apparatus for controlling a wireless connection according to a further aspect of the present disclosure. As shown in FIG. 6, the apparatus may be implemented in a mobile terminal, and may include a mobile detection module 601 and a mobile connection module 602.

The mobile detection module 601 may be configured to detect whether an electronic device entering a range of connection of a first connection protocol exists.

The mobile connection module 602 may be configured to establish a first connection with the electronic device through the first connection protocol when the electronic device is detected. The first connection protocol may be a connection protocol with power consumption that is lower than that for the wireless local area network function of the electronic device.

The apparatus may also include a communication module 603 configured to perform communication between the electronic device and a server through the first connection and a second connection, where the second connection is between the mobile terminal and the server.

Optionally, the second connection is a connection established by the mobile terminal with the server through the wireless local area network or a data network.

Optionally, the wireless local area network may include Wi-Fi, and the first connection protocol may include Bluetooth Low Energy BLE.

With respect to the apparatus in the above embodiments, the specific protocols for performing operations for individual modules therein have been described in detail in the embodiments regarding the relevant methods, which are not elaborated herein.

Accordingly, in the apparatus for controlling the wireless connection provided by the present embodiment, when the electronic device is connected to the server by accessing a WLAN provided by a router, once it is detected that a mobile terminal has entered a range of connection of a first connection protocol, the electronic device establishes a connection with the mobile terminal through the first connection protocol, and disable the WLAN function. The electronic device thus performs communication with the server via the mobile terminal through the first connection protocol which has a power consumption that is lower than that for the WLAN function. Thus, it may solve the problem that the power consumption is large for the connection between the electronic device and the server by reducing the power consumption for the wireless communication between the electronic device and the server.

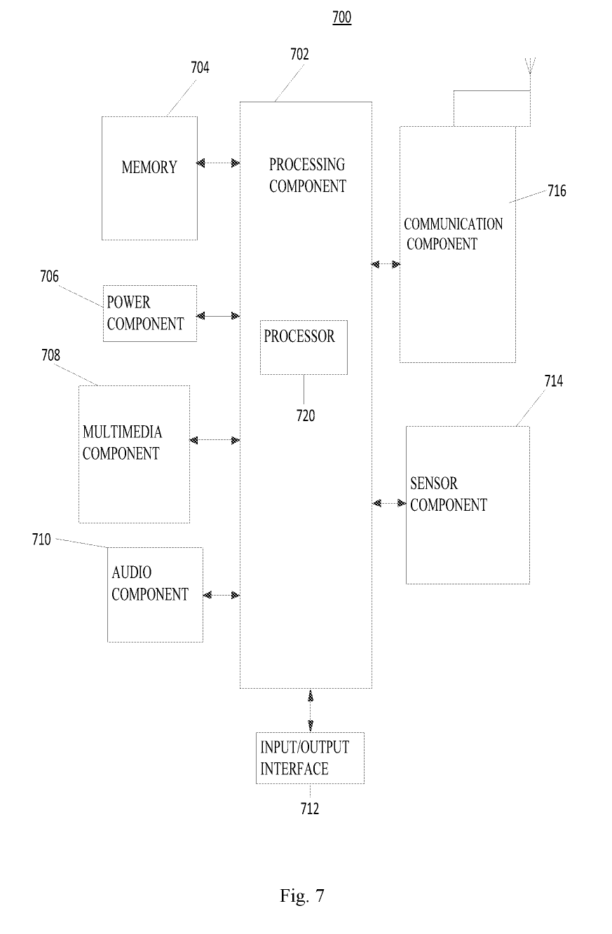

FIG. 7 is a block diagram illustrating an apparatus 700 configured to control a wireless connection according to an example of the present disclosure, which may be implemented in an electronic device.

As shown in FIG. 7 is an apparatus 700 for interacting with a button according to an example of the present disclosure. For example, the apparatus 700 may be a mobile phone, a computer, a digital broadcast terminal, a messaging device, a gaming console, a tablet, a medical device, exercise equipment, a personal digital assistant, and the like.

Referring to FIG. 7, the apparatus 700 may include one or more of the following components: a processing component 702, a memory 704, a power component 706, a multimedia component 708, an audio component 710, an input/output (I/O) interface 712, a sensor component 714, and a communication component 716.

The processing component 702 typically controls overall operations of the apparatus 700, such as the operations associated with display, telephone calls, data communications, camera operations, and recording operations. The processing component 702 may include one or more processors 720 to execute instructions to perform all or part of the steps in the above method for controlling the wireless connection. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 may be configured to store various types of data to support the operation of the apparatus 700. Examples of such data include instructions for any applications or methods operated on the apparatus 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the apparatus 700. The power component 706 may include a power management system, one or more power sources, and any other components associated with the generation, management, and distribution of power in the apparatus 700.

The multimedia component 708 includes a screen providing an output interface between the apparatus 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and the rear camera may receive an external multimedia datum while the apparatus 700 is in an operation mode, such as a photographing mode or a video mode. Each of the front camera and the rear camera may be a fixed optical lens system or have focus and optical zoom capability.

The audio component 710 may be configured to output and/or input audio signals. For example, the audio component 710 includes a microphone (“MIC”) configured to receive an external audio signal when the apparatus 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the apparatus 700. For instance, the sensor component 714 may detect an open/closed status of the apparatus 700, relative positioning of components, e.g., the display and the keypad, of the apparatus 700, a change in position of the apparatus 700 or a component of the apparatus 700, a presence or absence of user contact with the apparatus 700, an orientation or an acceleration/deceleration of the apparatus 700, and a change in temperature of the apparatus 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 may be configured to facilitate communication, wired or wirelessly, between the apparatus 700 and other devices. The apparatus 700 can access a wireless network based on a communication standard, such as WiFi, 2G, or 3G, or a combination thereof. In one example, the communication component 716 receives a broadcast signal or broadcast associated information from an external broadcast management system via a broadcast channel. In one example, the communication component 716 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In examples of present disclosure, the apparatus 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In examples of present disclosure, there is also provided a non-transitory computer-readable storage medium including instructions, such as included in the memory 704, executable by the processor 720 in the apparatus 700, for performing the above-described method for controlling the wireless connection. For example, the non-transitory computer-readable storage medium may be a ROM, a RAM, a CD-ROM, a magnetic tape, a floppy disc, an optical data storage device, and the like.

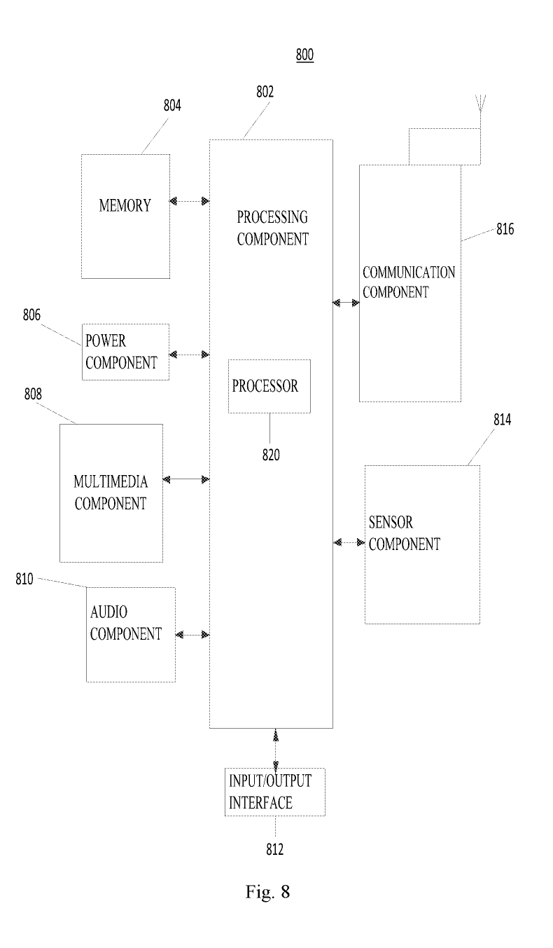

FIG. 8 is a block diagram illustrating another apparatus 800 configured to control a wireless connection according to another example of the present disclosure. For example, the apparatus 800 may be a mobile phone, a computer, a digital broadcast terminal, a messaging device, a gaming console, a tablet, a medical device, exercise equipment, a personal digital assistant, and the like.

Referring to FIG. 8, the apparatus 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the apparatus 800, such as the operations associated with display, telephone calls, data communications, camera operations, and recording operations. The processing component 802 may include one or more processors 820 to execute instructions to perform all or part of the steps in the above method for controlling the wireless connection. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 may be configured to store various types of data to support the operation of the apparatus 800. Examples of such data include instructions for any applications or methods operated on the apparatus 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the apparatus 800. The power component 806 may include a power management system, one or more power sources, and any other components associated with the generation, management, and distribution of power in the apparatus 800.

The multimedia component 808 includes a screen providing an output interface between the apparatus 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and the rear camera may receive an external multimedia datum while the apparatus 800 is in an operation mode, such as a photographing mode or a video mode. Each of the front camera and the rear camera may be a fixed optical lens system or have focus and optical zoom capability.

The audio component 810 may be configured to output and/or input audio signals. For example, the audio component 810 includes a microphone (“MIC”) configured to receive an external audio signal when the apparatus 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the apparatus 800. For instance, the sensor component 814 may detect an open/closed status of the apparatus 800, relative positioning of components, e.g., the display and the keypad, of the apparatus 800, a change in position of the apparatus 800 or a component of the apparatus 800, a presence or absence of user contact with the apparatus 800, an orientation or an acceleration/deceleration of the apparatus 800, and a change in temperature of the apparatus 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 may be configured to facilitate communication, wired or wirelessly, between the apparatus 800 and other devices. The apparatus 800 can access a wireless network based on a communication standard, such as Wi-Fi, 2G, or 3G, or a combination thereof. In one example, the communication component 816 receives a broadcast signal or broadcast associated information from an external broadcast management system via a broadcast channel. In one example, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In examples of present disclosure, the apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In examples of present disclosure, there is also provided a non-transitory computer-readable storage medium including instructions, such as included in the memory 804, executable by the processor 820 in the apparatus 800, for performing the above-described method for controlling the wireless connection. For example, the non-transitory computer-readable storage medium may be a ROM, a RAM, a CD-ROM, a magnetic tape, a floppy disc, an optical data storage device, and the like.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors.

Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method for controlling a wireless connection, comprising:
detecting that a mobile terminal is entering a range of a first network using a first connection protocol when an electronic device is connected to a server via a wireless local area network provided by a router;
establishing a first connection between the mobile terminal and the electronic device using the first connection protocol when the mobile terminal is detected to be within the range of the first network, wherein the first connection protocol causes the electronic device to have a power consumption that is lower than that required to communicate using the wireless local area network; and
disabling the wireless local area network for the electronic device, and performing communication between the electronic device and the server through the first connection and a second connection, wherein the second connection is used to connect the mobile terminal and the server.

2. The method of claim 1, further comprising:
enabling the wireless local area network for the electronic device when the first connection is disconnected, and
establishing a third connection between the electronic device and the router using the wireless local area network, and performing communication between the electronic device and the server through the third connection.

3. The method of claim 1, wherein the second connection is a connection established by the mobile terminal with the server using the wireless local area network or a data network.

4. The method of claim 1, wherein the wireless local area network comprises Wireless-Fidelity (Wi-Fi), and the first connection protocol comprises Bluetooth Low Energy (BLE) protocol.

5. An apparatus for controlling a wireless connection, comprising:
a processor; and
a memory for storing instructions executable by the processor;
wherein the processor is configured to cause the apparatus to:
detect that a mobile terminal is entering a range of a first network using a first connection protocol when an electronic device is connected to a server via a wireless local area network provided by a router;
establish a first connection between the mobile terminal and the electronic device using the first connection protocol when the mobile terminal is detected to be within the range of the first network, wherein the first connection protocol causes the electronic device to have a power consumption that is lower than that required to communicate using the wireless local area network; and
disable the wireless local area network for the electronic device, and perform communication between the electronic device and the server through the first connection and a second connection, wherein the second connection is used to connect the mobile terminal and the server.

6. The apparatus of claim 7, wherein the processor is further configured to:
enable the wireless local area network for the electronic device when the first connection is disconnected, and
establish a third connection between the electronic device and the router using the wireless local area network, and performing communication between the electronic device and the server through the third connection.

7. The apparatus of claim 7, wherein the second connection is a connection established by the mobile terminal with the server using the wireless local area network or a data network.

8. The apparatus of claim 7, wherein the wireless local area network comprises Wi-Fi, and the first connection protocol comprises BLE.

9. A non-transitory computer-readable storage medium having stored therein instructions that, when executed by a processor of an electronic device, cause the electronic device to:
detect that a mobile terminal is entering a range of a first network using a first connection protocol when an electronic device is connected to a server via a wireless local area network provided by a router;
establish a first connection between the mobile terminal and the electronic device using the first connection protocol when the mobile terminal is detected to be within the range of the first network, wherein the first connection protocol causes the electronic device to have a power consumption that is lower than that required to communicate using the wireless local area network; and
disable the wireless local area network for the electronic device, and perform communication between the electronic device and the server through the first connection and a second connection, wherein the second connection is used to connect the mobile terminal and the server.

10. The non-transitory computer-readable storage medium of claim 13, wherein the instructions further cause the electronic device to:
enable the wireless local area network for the electronic device when the first connection is disconnected, and
establish a third connection between the electronic device and the router using the wireless local area network, and performing communication between the electronic device and the server through the third connection.

11. The non-transitory computer-readable storage medium of claim 13, wherein the second connection is a connection established by the mobile terminal with the server using the wireless local area network or a data network.

12. The non-transitory computer-readable storage medium of claim 13, wherein the wireless local area network comprises Wi-Fi, and the first connection protocol comprises BLE.
